(19) United States
(12) Patent Application Publication
(10) Pub. No.: US 2004/0005055 A1
(43) Pub. Date: Jan. 8, 2004

(54) Method and system for digital watermarking

(76) Inventors: Paul L. Master, Sunnyvale, CA (US); John Watson, Edgewood, WA (US)

Correspondence Address: SAWYER LAW GROUP LLP, P O BOX 51418, PALO ALTO, CA, 94303, US

(21) Appl. No.: 10/020,149

(22) Filed: Dec. 6, 2001

(51) Int. Cl. H04N 7/167

(52) U.S. Cl. 380/205

(57) ABSTRACT

Aspects of digital watermarking are described. These aspects include utilizing a data stream to configure operations of an adaptive computing engine, and embedding dynamic watermarking data within the data stream to provide identifying indicia for the adaptive computing engine. A further aspect includes providing dynamic watermarking data within a data stream, marking a combination of computational elements configured by data within the data stream with the dynamic watermarking data, and marking one or more algorithms, included in the data stream and to be performed by the combination of computational elements, with the dynamic watermarking data.

### FIELD OF THE INVENTION

The present invention relates to digital watermarking.

### BACKGROUND OF THE INVENTION

Current technology has allowed an increase in the number and types of opportunities for transmission of information from content providers in a variety of forms, such as movies, television programming and the like. Recently, greater emphasis has been placed on providing digital content. As is generally known in the art and described in U.S. Pat. No. 6,282,650, “digital content” involves the transmission of one or more digitized data sets. Each “data set” includes data with perceivable content (e.g., a still image, a frame of video, alphanumeric character representations, audio, Internet Protocol “IP” commands, a program, etc.). Unlike analog, digital content can be easily manipulated without affecting the quality of the original data set. This “quality” may be measured through visual clarity of an image, audible clarity during audio playback, accuracy of characters in text or code, as well as other factors. Since digital content can be easily manipulated, content providers have been hesitant in supporting digital content distribution, in part, due to the absence of a mechanism to protect against unauthorized copying and/or illegal distribution of their digital content.

Recently, digital watermarking has emerged as a technique to protect against unauthorized copying and distribution of digital content. In general, “digital watermarking” comprises an act of embedding information (referred to as a “watermark”) into the data set in an unobtrusive way so that the quality of the data set is not reduced, but the watermark can be extracted as the data set is being used. This is accomplished by placing the watermark into a noise band of the data set. The “noise band” may include, for example, a few least significant bits associated with the color of each pixel of an image.

In addition, a watermark may be embedded to be resilient to various manipulations of the data set such as, for example, photocopying, scanning, resizing, cropping and color manipulation. Of course, the selected degree of resiliency is determined by the amount of information that can be embedded in a data set. As an illustrative example, if resiliency to cropping is desired, a watermark is placed in a redundant fashion in different portions of the data set. If such cropping resiliency is not desired, bandwidth consumed by such redundancy may be allocated to improve the quality of the data set.

Two types of watermarks include public watermarks and private watermarks. These watermarks serve different functions. For example, a “public watermark” is readable by widely-available software and is generally used to enable a consumer of the data set to identify its source. As a result, public watermarks are used to embed copyright notices, licensing contacts or other information. This information can be obtained by consumers through use of the widely-available software. However, public watermarks are relatively simple to remove or to forge.

A “private watermark” is a digital watermark embedded using a technique similar to symmetric key cryptography, but the key is held in secrecy, known only to the person or entity applying the private watermark who is normally the original owner of the content. For reading purposes, locating the private watermark in the data set requires knowledge of the secret key, and thus, the private watermark is not easy to remove. This allows an original owner to identify copyright violations and prove ownership of the data set. In this manner, greater protection of the data set is achieved.

As the proliferation of digital content increases, a need remains for a reliable and effective digital watermarking approach. The present invention addresses such a need.

### SUMMARY OF THE INVENTION

Aspects of digital watermarking are described. These aspects include utilizing a data stream to configure operations of an adaptive computing engine, and embedding dynamic watermarking data within the data stream to provide identifying indicia for the adaptive computing engine. A further aspect includes providing dynamic watermarking data within a data stream, marking a combination of computational elements configured by data within the data stream with the dynamic watermarking data, and marking one or more algorithms, included in the data stream and to be performed by the combination of computational elements, with the dynamic watermarking data.

With the present invention, greater flexibility for utilizing a digital watermark is achieved in a straightforward and effective manner. The ability to include the watermarking data within the data stream allows for the realization of a dynamic digital watermark. Further, the present invention improves the quality of digital watermarking by increasing its functionality and providing protection and identification of both hardware and software of a device. These and other advantages will become readily apparent from the following detailed description and accompanying drawings.

### BRIEF DESCRIPTION OF THE DRAWINGS

FIG. 1 is a block diagram illustrating an adaptive computing engine.

FIG. 2 is a block diagram illustrating, in greater detail, a reconfigurable matrix of the adaptive computing engine.

FIG. 3 is a diagram illustrating a data stream for the adaptive computing engine including dynamic watermarking data within a system representation in accordance with the aspects of the present invention.

### DETAILED DESCRIPTION OF THE INVENTION

The present invention relates to digital watermarking. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In a preferred embodiment, the processing core of an embedded system is achieved through an adaptive computing engine (ACE). A more detailed discussion of the aspects of an ACE are provided in co-pending U.S. patent application Ser. No. 09/815,122, entitled ADAPTIVE INTEGRATED CIRCUITRY WITH HETEROGENEOUS AND RECONFIGURABLE MATRICES OF DIVERSE AND ADAPTIVE COMPUTATIONAL UNITS HAVING FIXED, APPLICATION SPECIFIC COMPUTATIONAL ELEMENTS, filed Mar. 22, 2001, assigned to the assignee of the present invention, and incorporated herein in its entirety. Generally, the ACE provides a significant departure from the prior art for achieving processing in an embedded system, in that data, control and configuration information are transmitted between and among its elements, utilizing an interconnection network, which may be configured and reconfigured, in real-time, to provide any given connection between and among the elements. In order to more fully illustrate the aspects of the present invention, portions of the discussion of the ACE from the application incorporated by reference are included in the following.

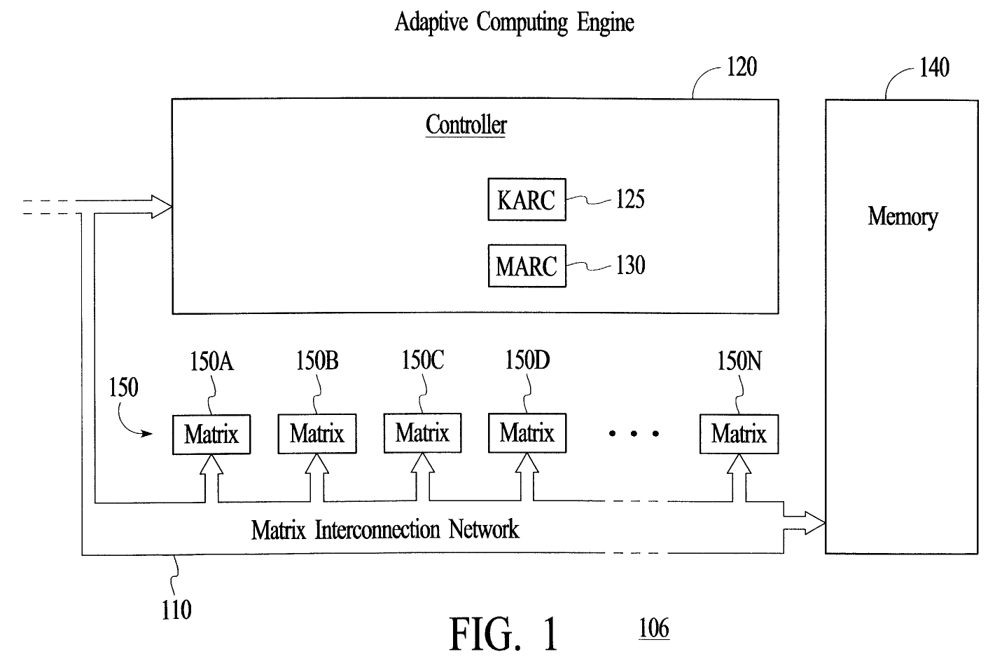

FIG. 1 is a block diagram illustrating an adaptive computing engine (“ACE”) 106 that includes a controller 120, one or more reconfigurable matrices 150, such as matrices 150A through 150N as illustrated, a matrix interconnection network 110, and preferably also includes a memory 140.

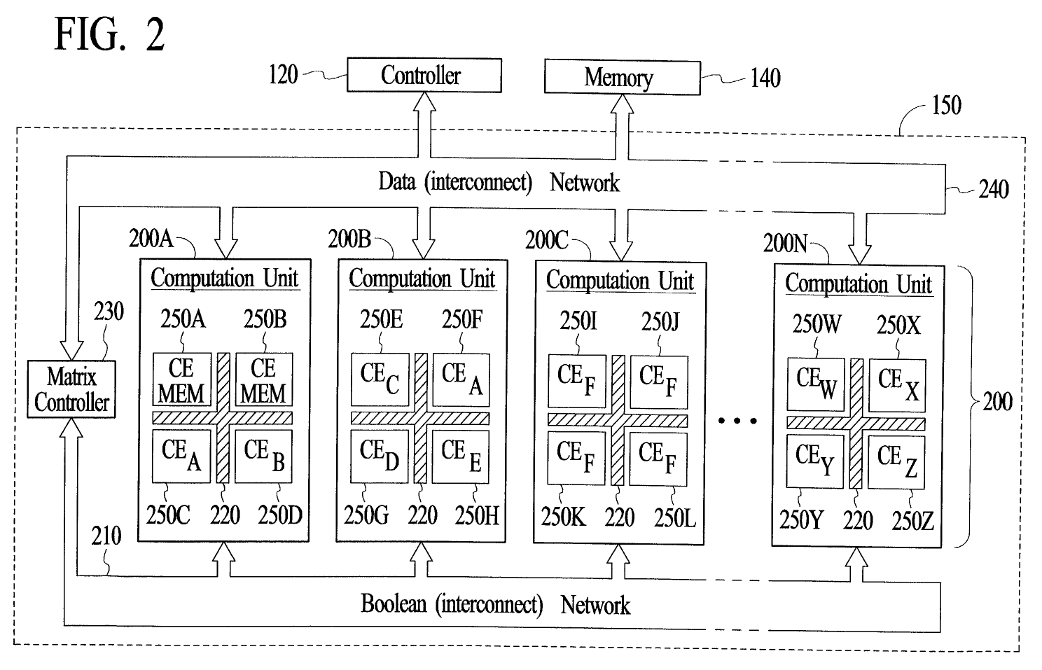

FIG. 2 is a block diagram illustrating, in greater detail, a reconfigurable matrix 150 with a plurality of computation units 200 (illustrated as computation units 200A through 200N), and a plurality of computational elements 250 (illustrated as computational elements 250A through 250Z), and provides additional illustration of the preferred types of computational elements 250 and a useful summary of aspects of the present invention. As illustrated in FIG. 2, any matrix 150 generally includes a matrix controller 230, a plurality of computation (or computational) units 200, and as logical or conceptual subsets or portions of the matrix interconnect network 110, a data interconnect network 240 and a Boolean interconnect network 210. The Boolean interconnect network 210 provides the reconfigurable interconnection capability between and among the various computation units 200, while the data interconnect network 240 provides the reconfigurable interconnection capability for data input and output between and among the various computation units 200. It should be noted, however, that while conceptually divided into reconfiguration and data capabilities, any given physical portion of the matrix interconnection network 110, at any given time, may be operating as either the Boolean interconnect network 210, the data interconnect network 240, the lowest level interconnect 220 (between and among the various computational elements 250), or other input, output, or connection functionality.

Continuing to refer to FIG. 2, included within a computation unit 200 are a plurality of computational elements 250, illustrated as computational elements 250A through 250Z (collectively referred to as computational elements 250), and additional interconnect 220. The interconnect 220 provides the reconfigurable interconnection capability and input/output paths between and among the various computational elements 250. Each of the various computational elements 250 consist of dedicated, application specific hardware designed to perform a given task or range of tasks, resulting in a plurality of different, fixed computational elements 250. Utilizing the interconnect 220, the fixed computational elements 250 may be reconfigurably connected together to execute an algorithm or other function, at any given time.

In a preferred embodiment, the various computational elements 250 are designed and grouped together, into the various reconfigurable computation units 200. In addition to computational elements 250 which are designed to execute a particular algorithm or function, such as multiplication, other types of computational elements 250 are also utilized in the preferred embodiment. As illustrated in FIG. 2, computational elements 250A and 250B implement memory, to provide local memory elements for any given calculation or processing function (compared to the more “remote” memory 140). In addition, computational elements 250I, 250J, 250K and 250L are configured (using, for example, a plurality of flip-flops) to implement finite state machines, to provide local processing capability, especially suitable for complicated control processing.

With the various types of different computational elements 250 which may be available, depending upon the desired functionality of the ACE 106, the computation units 200 may be loosely categorized. A first category of computation units 200 includes computational elements 250 performing linear operations, such as multiplication, addition, finite impulse response filtering, and so on. A second category of computation units 200 includes computational elements 250 performing non-linear operations, such as discrete cosine transformation, trigonometric calculations, and complex multiplications. A third type of computation unit 200 implements a finite state machine, such as computation unit 200C as illustrated in FIG. 2, particularly useful for complicated control sequences, dynamic scheduling, and input/output management, while a fourth type may implement memory and memory management, such as computation unit 200A as illustrated in FIG. 2. Lastly, a fifth type of computation unit 200 may be included to perform bit-level manipulation, such as for encryption, decryption, channel coding, Viterbi decoding, and packet and protocol processing (such as Internet Protocol processing).

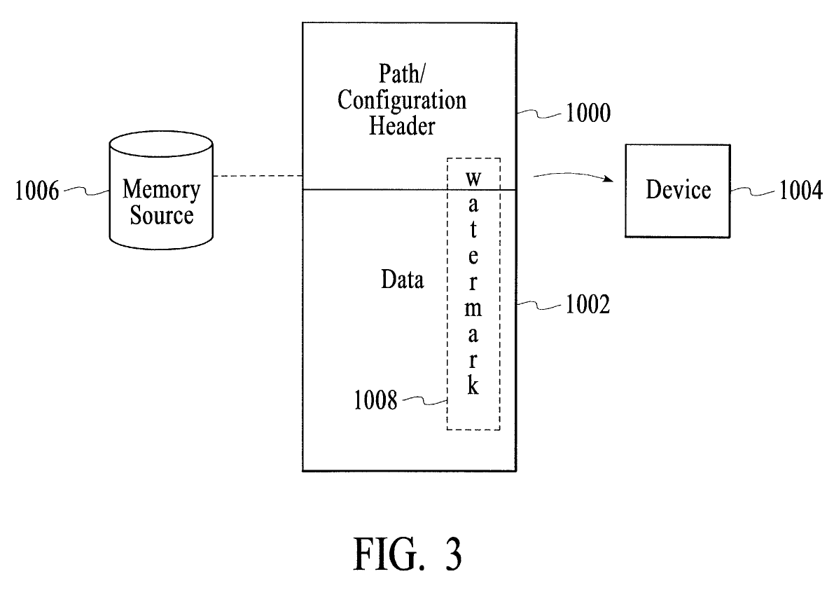

The ability to configure the elements of the ACE relies on a tight coupling (or interdigitation) of data and configuration (or other control) information, within one, effectively continuous stream of information. As illustrated in the diagram of FIG. 3, the continuous stream of data can be characterized as including a first portion 1000 that provides adaptive instructions and configuration data and a second portion 1002 that provides data to be processed. This coupling or commingling of data and configuration information, referred to as a “silverware” module, helps to enable real-time reconfigurability of the ACE 106, and in conjunction with the real-time reconfigurability of heterogeneous and fixed computational elements 250, to form different and heterogenous computation units 200 and matrices 150, enabling the ACE 106 architecture to have multiple and different modes of operation. For example, when included within a hand-held device, given a corresponding silverware module, the ACE 106 may have various and different operating modes as a cellular or other mobile telephone, a music player, a pager, a personal digital assistant, and other new or existing functionalities. In addition, these operating modes may change based upon the physical location of the device; for example, when configured as a CDMA mobile telephone for use in the United States, the ACE 106 may be reconfigured as a GSM mobile telephone for use in Europe.

As an analogy, for the reconfiguration possible via the silverware modules, a particular configuration of computational elements, as the hardware to execute a corresponding algorithm, may be viewed or conceptualized as a hardware analog of “calling” a subroutine in software which may perform the same algorithm. As a consequence, once the configuration of the computational elements has occurred, as directed by the configuration information, the data for use in the algorithm is immediately available as part of the silverware module. The immediacy of the data, for use in the configured computational elements, provides a one or two clock cycle hardware analog to the multiple and separate software steps of determining a memory address and fetching stored data from the addressed registers.

As further shown in the system representation of FIG. 3, a device 1004 operating via an ACE is configured for operation upon receipt of the data stream from a memory source 1006, such as a file memory, RAM, ROM, disk drive, Flash, etc. In accordance with the present invention, a dynamic digital watermark 1008 is included within the data stream to ensure authenticity of the data stream. Because the data stream provides the data to configure computational elements as the hardware and the data for the algorithms to be executed by these computational elements, the inclusion of the dynamic digital watermark 1008 within the data stream allows greater protection by marking both the hardware and software of the device 1004.

The inclusion of the dynamic digital watermark 1008 in the data stream suitably occurs during one of several points of data stream processing. A first option is to include the dynamic digital watermark 1008 during the creation of the data stream in a compiler, e.g., as an “add signature” step in the tool flow of the processing system that creates the data stream. Alternatively, the dynamic digital watermark 1008 can be added to a data stream that has been compiled and is already residing in memory 1006 or as the data stream is transmitted from memory 1006 to the device 1004, such as through a network connection, the Internet, a wireless connection, etc. As yet another alternative, the dynamic digital watermark 1008 may be added as the data stream executes in the device 1004.

Further alternatives are available as to the location of the dynamic digital watermark 1008 within the data stream, as indicated by the use of the dashed box surrounding the dynamic digital watermark 1008 in FIG. 3. In one embodiment, the dynamic digital watermark 1008 can be localized within a particular partition of the data stream. Alternatively, the bits of the dynamic digital watermark 1008 may be spread out throughout the data stream, e.g., in bit locations that don't affect the operation of element(s) being configured by the data stream. The bits of data may also be included in the data stream as a dynamic element.

The ability to include the watermarking data within the data stream allows for the realization of a dynamic digital watermark in accordance with the present invention. For example, if there was a predetermined limit on the number of times a program could be performed by a user, the data stream could include watermarking data that would configure a finite state machine within the ACE that would track the number of times a program was performed. Once the limit was reached, an additional function may be utilized to request procurement of a fee that would allow further utilization of the program, such as a request for a user to enter a credit card number. In this manner, the watermarking data expands the capabilities of protecting digital data through marking by further providing the ability to control access to the device utilizing the data. Additional capabilities include the ability to log statistics, such as number of times the ACE being watermarked is accessed, and to perform events, such as starting other programs, e.g., making a request for a credit card number. Thus, the present invention improves the quality of digital watermarking by increasing its functionality and providing protection and identification of both hardware and software of a device.

From the foregoing, it will be observed that numerous variations and modifications may be effected without departing from the spirit and scope of the novel concept of the invention. Further, it is to be understood that no limitation with respect to the specific methods and apparatus illustrated herein is intended or should be inferred. It is, of course, intended to cover by the appended claims all such modifications as fall within the scope of the claims.

What is claimed is:

1. A method for digital watermarking, the method comprising:
utilizing a data stream to configure operations of an adaptive computing engine; and
embedding dynamic watermarking data within the data stream to provide identifying indicia for the adaptive computing engine.

2. The method of claim 1 wherein embedding further comprises adding the dynamic watermarking when the data stream is created by a compiler.

3. The method of claim 1 wherein embedding further comprises adding the dynamic watermarking data when the data stream is received in memory.

4. The method of claim 1 wherein embedding further comprises adding the dynamic watermarking data while the data stream is transported from memory to the adaptive computing engine.

5. The method of claim 1 wherein embedding further comprises adding the dynamic watermarking data when the data stream is executing as the adaptive computing engine.

6. The method of claim 1 wherein utilizing a data stream further comprises configuring a hardware state machine within the adaptive computing engine to extract and process the dynamic watermarking data.

7. The method of claim 6 wherein processing the dynamic watermarking data further comprises controlling access to the adaptive computing engine.

8. The method of claim 7 wherein processing the dynamic watermarking data further comprises logging statistics of the adaptive computing engine.

9. The method of claim 8 wherein processing the dynamic watermarking data further comprises performing events.

10. The method of claim 9 determining a number of times access to the adaptive computing engine is allowed, tracking a number of times the adaptive computing engine is accessed, and ending access with the number of times has been exhausted.

11. The method of claim 10 initiating acquisition of additional fee payment for continued utilization of the adaptive computing engine.

12. A system for digital watermarking, the system comprising:
an adaptive computing engine (ACE); and
a data stream for configuring operations in the ACE, the data stream including dynamic watermarking data to provide identifying indicia for the ACE.

13. The method of claim 12 wherein the data stream further comprises a first portion including adaptive instructions and configuration data and a second portion including data to be processed.

14. The method of claim 13 wherein the data stream further comprises the dynamic watermarking data as a third portion.

15. The method of claim 13 wherein the data stream further comprises the dynamic watermarking data spread across the first and second portions.

16. The method of claim 12 wherein the data stream further comprises data for configuring a hardware state machine within the ACE to extract and process the dynamic watermarking data.

17. The method of claim 16 wherein the data stream further comprises data for controlling access to the adaptive computing engine.

18. The method of claim 17 wherein the data stream further comprises data for logging statistics of the adaptive computing engine.

19. The method of claim 18 wherein the data stream further comprises data for performing events.

20. The method of claim 19 wherein the data stream further comprises data for determining a number of times access to the adaptive computing engine is allowed, tracking a number of times the adaptive computing engine is accessed, and ending access with the number of times has been exhausted.

21. The method of claim 12 wherein the ACE further comprises a controller, one or more reconfigurable matrices, a matrix interconnection network, and a memory.

22. A method for digital watermarking, the method comprising:
providing dynamic watermarking data within a data stream;
marking a combination of computational elements, configured by data within the data stream, with the dynamic watermarking data; and
marking one or more algorithms, included in the data stream and to be performed by the combination of computational elements, with the dynamic watermarking data.

23. The method of claim 22 wherein providing further comprises adding the dynamic watermarking when the data stream is created by a compiler.

24. The method of claim 22 wherein providing further comprises adding the dynamic watermarking data when the data stream is received in memory.

25. The method of claim 22 wherein providing further comprises adding the dynamic watermarking data while the data stream is transported from memory to an adaptive computing engine formed by the combination of computational elements and the one or more algorithms.

26. The method of claim 22 wherein providing further comprises adding the dynamic watermarking data when the data stream is executing as an adaptive computing engine.
